(19) United States
(12) Patent Application Publication
(10) Pub. No.: US 2018/0105099 A1
(43) Pub. Date: Apr. 19, 2018

(54) LED LIGHT MODULE FOR A LIGHTING DEVICE FOR VEHICLES

(71) Applicant: ZKW GROUP GMBH, Wieselburg (AT)

(72) Inventors: Emanuel WEBER, Baden (AT); Roland WACHTER, Grafenschachen (AT)

(21) Appl. No.: 15/578,725

(22) PCT Filed: May 30, 2016
(86) PCT No.: PCT/AT2016/050168

§ 371 Date: Dec. 1, 2017

(30) Foreign Application Priority Data
Jun. 1, 2015 (AT) A 50443/2015

(51) Int. Cl. B60Q 1/26; B60Q 1/32; B60Q 3/80; F21V 8/00

(52) U.S. Cl. CPC B60Q 1/2661; B60Q 1/2696; F21Y 2115/10; B60Q 3/80; G02B 6/0096; B60Q 1/323

(57) ABSTRACT

The invention relates to a LED light module (M) for a lighting device for vehicles, which LED light module has at least one LED branch having at least one LED (LED1 . . . LEDn), wherein at least one component (R_{R}) for identifying a bin class is arranged on the module, and the module is designed for operation with a total current (I_{G}), and an analog controller (3, T2) for branching off a partial current (I_{B}) is connected in parallel with the LED branch (Z) carrying a partial current (I_{D}) of the total current (I_{G}), wherein a signal (U_{S}) corresponding to the total current (I_{G}) is fed to the analog controller as a reference variable and a signal (U_{R}) proportional to one of the partial currents (I_{B}, I_{D}) and provided by the component (R_{R}) for identifying the bin class is fed to the analog controller as a control variable.

The invention relates to a LED light module for a lighting device for vehicles, which LED light module has at least one LED branch having at least one LED, wherein at least one component for identifying a bin class is arranged on the module, and the module is designed for operation with a total current.

According to the current state of the art, for almost all light functions of lamps of vehicles a separate LED circuit board including a preconnected driver has to be developed. This circumstance is undesirable in particular with respect to a desired replaceability of a light source. For this reason and due to the increase of LEDs as lighting means in the automotive sector, among other things, the desire for standardized LEDs has risen. Such light sources have to be specified in order for each light source to be replaceable, wherein also light sources of different manufacturers may be used. Among other specification criteria, the current consumption for a given light intensity and light color has to be standardized. The control apparatus provided upstream of the light source or the driver electronics connected to the same source controls this standardized current, regardless of the light source which is connected at its output.

A particular challenge lies in the possibility to use different LEDs and in particular LEDs with different brightness bins (“binning” is to be considered as a classification of a LED-production, for example with reference to brightness, light flow, color tone, etc., in “bins”). If LEDs are operated with different brightness-bin with the same current, they light up with different brightness, and this would obviously provide, in case of changing the LEDs, different brightness levels, so that a simple replacement cannot be taken into consideration. A standardized light source thus has to have a suitable circuitry, which contrasts this problem, i.e. different brightness levels in case of replacement.

Such standardized light sources have also to allow the usual control of LEDs. For example, the light sources should be dimmable through PWM and also in an analog manner, through the current. If the control apparatus sets a given value, such as an analog dimming at 60%, also the actual current flowing through the LED has to be dimmed to this value.

In order to solve this problem of said differences in brightness, a parallel resistor may be provided, in parallel to the series connection of two or more LEDs, wherein the value of the resistance is chosen depending on the brightness class. A possible corresponding coding of LEDs according to brightness classes and a corresponding parallel connection of resistors is disclosed, for example, in DE 198 14495 A1. Even though this solution is simple, it has the drawback, that it entails large tolerances, since depending on the forward voltage of LEDs, which depends on the binning as well as on the temperature, different LED-currents are obtained, so that the brightness in each operating condition is different and varies strongly between LEDs with different binning. Moreover, in the parallel resistor electric energy is needlessly converted into heat, which in particular in case of a huge number of LED-light sources, in particular on vehicles, may be very disadvantageous.

Instead of using said parallel resistors, a bypass branch with a linear controller may also be used. In connection with a dimmable light source, a similar circuit has been known from EP 2797386 A1. The problem to be solved in this case is that LEDs during dimming—contrary to incandescent bulbs—only slightly vary their light color. However, in order to achieve the same effect as with incandescent bulbs in the case of dimming of LEDs, white LEDs are operated together with yellow LEDs and through a bypass the current of the one type of LED is controlled by branching a partial current. Due to the object posed, regarding influencing the light color mix of two LED types during dimming or the simulation of the behavior of an incandescent bulb, solutions are rather complex.

An object of the invention is to provide a LED-light module, which may be easily connected to a generally controlled current source, wherein the corresponding bin classification is automatically and “intelligently” taken into consideration.

This object is achieved with a LED-light module of said type, in which, according to the invention, in parallel to the LED branch carrying one partial current of the total current, an analog controller for branching a partial current is switched on, wherein the analog controller is provided, as a reference variable, with a signal, which corresponds to the total current, and as a control variable a signal is provided, which is proportional to one of the partial currents, and which is provided by the component for identifying the bin class.

In the module of the invention, LEDs or LED combinations of the standard type may be used without any problem, wherein the replacement of modules is easily accomplished, since the binning or the respective binning class is “intelligently” taken into consideration. In the context of the present invention, the term “LED” should refer to light diodes of any kind, which are considered for use in light means for vehicles, for example also laser diodes alone or in combination with light-converting means or substances (“phosphor”).

In a suitable variant of the invention the control variable is proportional to the partial current branched by the analog controller. To this end, it may be convenient, if in the branch of the analog controller, a resistor is provided for identifying a bin class and the voltage drop taking place on the resistor is supplied to the analog controller as a control variable.

In another possible embodiment, which has been successful in practice, it is provided that the control variable is proportional to the partial current flowing through the LED branch. Hereby in the LED branch for identifying the bin class a resistor may be advantageously disposed, and the voltage drop on the same is supplied to the analog controller as a control variable.

The invention also provides the advantage of a more uniform loading on the power supply, when the power supply has a control input, which may be provided with a control signal for dimming/switching the LEDs of the LED-light module.

The invention together with its advantages is explained in the following by means of exemplary embodiments, which are shown in the drawing. In particular

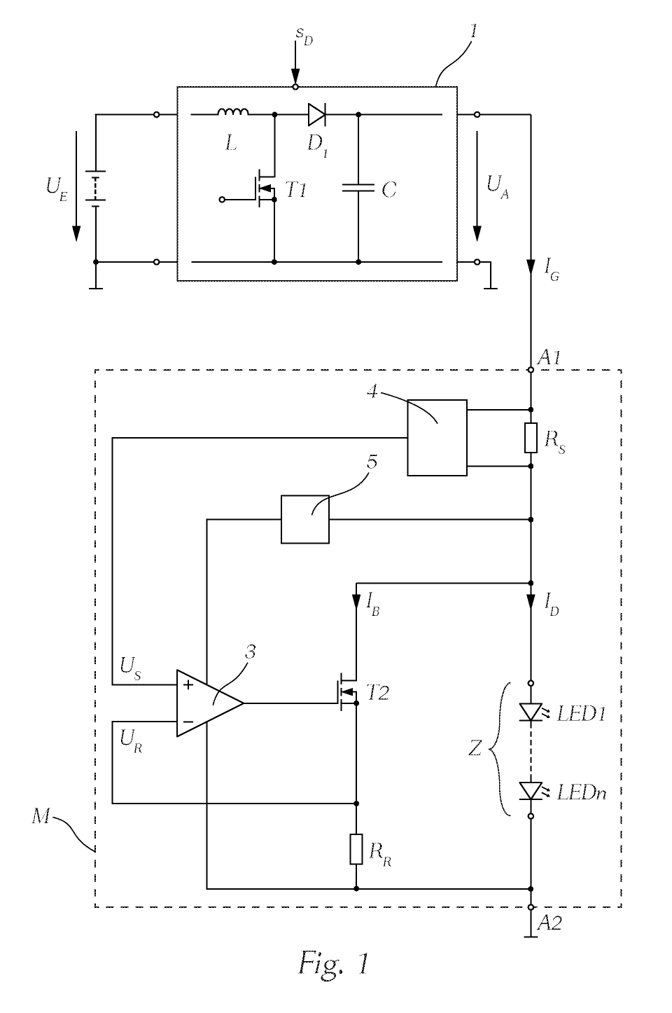

FIG. 1 shows a first exemplary embodiment of a LED-light module of the invention and

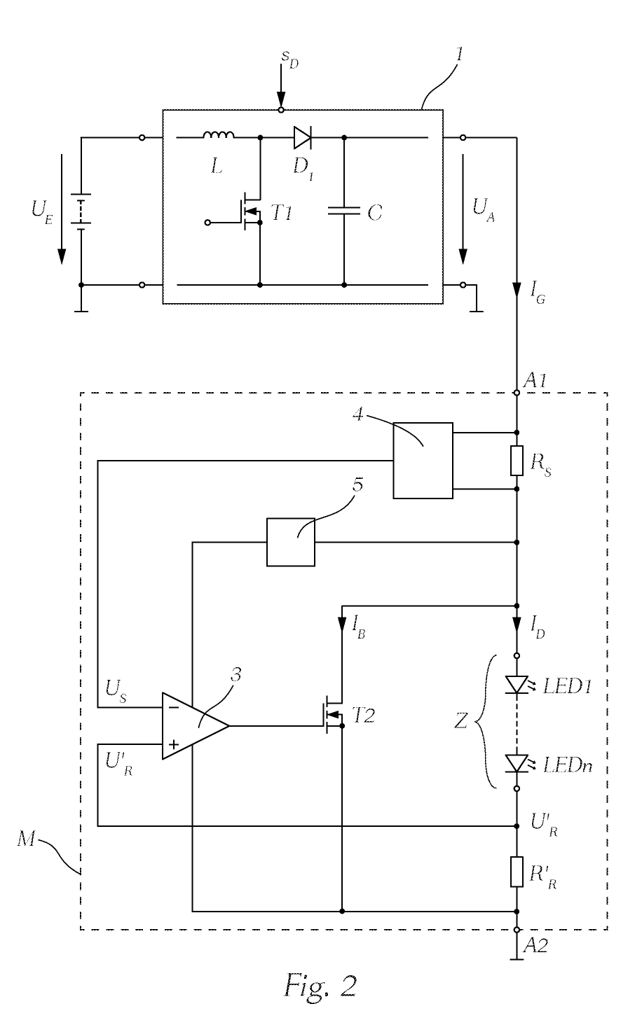

FIG. 2 shows a variant of the LED-light module of FIG. 1.

In the first variant shown in FIG. 1 of a LED-light module according to the invention, a voltage source U_{E} is shown, which may be a rechargeable battery of a motor vehicle, for example, wherein in the present case, this voltage source U_{E} is positioned after an up-converter 1, in which, only schematically, an inductor L, a switch transistor T1, a rectifier diode D1 and a capacitor C are shown. A power supply of this kind or a different power supply is provided on a vehicle, belongs to the state of the art and does not form part of the invention. The power supply supplies an output voltage U_{A} and provides a module M of the invention with a total current I_{G}.

In the module or at the module a sensor resistor R_{S} is provided in a series branch of light diodes LED1, . . . LEDn, wherein through the module, if it is adequately positioned in the vehicle and connected with the power supply, the total current I_{G} flows from a first terminal to a second terminal.

The series branch of light diodes, in the following in brief LED-branch Z, contains a number of light diodes adapted to the power supply voltage U_{A}, in the simplest case, a single light diode.

The LED-light module according to the invention may be used for a vehicle headlight, e blinking light, an auxiliary light or an inner lighting.

According to the invention, a controlled or feedback controlled parallel electric circuit is provided to the series connection of LEDs, which is provided as an analog, preferably linear current controller and in the present case is provided with a transistor T2, such as a FET, which is parallel connected to the light diode-series branch, with which a control resistor R_{R} is series connected. The resistor R_{R} is provided as a component for identifying the bin class of the LED module M and adapted according to the LEDs LED1 . . . LEDn provided on module M.

A portion of the total current I_{G} detected by the sensor resistor R_{R} flows through the LED branch, as a current I_{D} and a portion flows through the parallel branch as a current I_{B}, in this case through the transistor T2. The transistor is driven by an operational amplifier 3, which is provided with the following variables: on one hand, as a control variable U_{R}, a voltage U_{R} proportional to the branched current I_{B}, present on resistor R_{R} and, on the other hand, the output signal of a differential amplifier 4, which provides a voltage U_{S}, which is proportional to the total current I_{G}, which flows through the sensor resistor R_{S}, which is at the input of the differential amplifier 4. The operational amplifier 3 may be provided with the voltage, which is provided on the LED branch Z, either directly, or, as shown in FIG. 1, from a voltage supply component 5, such as an LDO (Low-Dropout Regulator).

The voltage at the reference input of the operational amplifier 3 is defined by the total current I_{G}, which is preset by the upstream control apparatus, in this case the up-converter 1. If this current is reduced or increased, also the voltage on the reference input of the operational amplifier 3 is increased.

The resistor R_{S} provides the reference voltage, which depends on the total current I_{G}. If now the current through the transistor branch Z and thus the voltage drop on R_{R} is higher than the reference voltage, then the transistor is closed further, until an equilibrium is obtained. The contrary holds if the voltage drop on R_{R} is too low.

The resistor R_{R} has to be adapted to the provided LEDs, i.e. it is used as a component for identifying the bin class of module M.

To clarify the matter, a numerical example is provided:

The total output current I_{G} of the power supply is equal to 1 A and the resistance of resistor R_{S} is equal to 1 Ohm. The voltage drop on R_{S} then is 1 A×1 Ohm=1 V.

If the provided LEDs require 1A in order to generate the defined brightness, the parallel control is not operative and thus should consequently not be provided on the light module.

If, however, the fitted LEDs LED1 . . . LEDn only require 0.6 A, i.e. 0.4 A have to flow through the branch of transistor T2, the bin-classifying resistor R_{R} is chosen with 1/0.4 Ohm (2.5 Ohm), then 2.5 Ohm×0.4 A=1 V.

Here, in this variant, the advantage is that only the lost power occurs, which has to be effectively “destroyed”, and no additional power loss is caused by the bin-classifying resistor.

The variant of the invention shown in FIG. 2 essentially corresponds to the embodiment of FIG. 1, wherein the same or like elements are provided with the same references. The difference to the module of FIG. 1 is that in this case the resistor R_{R}, from which a voltage U_{R′} is tapped, as a control variable, is disposed in the series branch of light diodes LED1 . . . LEDn. In this embodiment, the component for identifying the bin class of light module M is the resistor R_{R}, which, as in the embodiment of FIG. 1, may be disposed, together with light diodes LED1 . . . LEDn, for example, on a circuit carrier, such as a circuit board/printed board, wherein the entire module is advantageously provided for an easy replacement.

The function of the embodiment of FIG. 2 is the same as in the embodiment of FIG. 1. In this variant also the resistor R_{R} provides the reference voltage, which depends on the total current I_{G}. In this variant, the resistor R′_{R} defines the bin class of the mounted LEDs and is positioned in the series branch of light diodes LED1 . . . LEDn. If the current through the LED branch and thus the voltage drop on R′_{R} is larger than the reference voltage, the transistor T2 is opened further, until an equilibrium is set. The opposite is true for the case in which the voltage drop on R′_{R} is too low.

In order to provide a better explanation, here also a numerical example is provided, wherein again the total output current I_{G} of power supply is 1 A and the resistance of resistor R_{S} is 1 Ohm. The voltage drop on R_{S} is then 1 A×1 Ohm=1 V.

If the provided LEDs require 1 A, in order to generate the defined brightness, the parallel control is not operative anymore, and it should consequently not even be mounted on the light module.

If, however, the provided LEDs require 0.6 A, then the bin classifying resistor R′_{R} is chosen with 1/0.6 Ohm (1,6667 Ohm), and 1,6667 Ohm×0.6 A=1 V.

The drawback in this case is the additional power lost on bin resistor R′_{R} and the “optimized” variant is thus a variant with a bin classifying resistance in the branch of the analog controller, in these examples, to be precise, in the branch of transistor T2.

It is thus to be noted, that the embodiment of FIG. 1 is to be preferred in many cases, since in this embodiment, only the power is converted to heat, which due to brightness pins of LEDs has to be disposed of, whereas in embodiment of FIG. 2, the resistor generating losses is in the LED series branch, and does not possibly generate undesired losses in that position, which, in the individual case obviously depends on the power of LEDs or the current I_{D} in the series circuit.

For operation, it is in principle unimportant where the resistor is positioned. In both cased the control is performed at a determined LED-current I_{D}, in the examples described, at 0.6 A.

In general, a resistor is suitable as a component identifying bin classes of light module M, although, citing another example, to this end, also another current controlled power supply could be used, such as a component with a non-linear current/voltage characteristic curve.

It is also to be noted that the voltage/current supply of the inventive LED module M, which in the present example is an up-converter, may be provided with a control signal SD, which is used for example for dimming the light diodes or for blinking, i.e. a periodic switching on/off, etc. With the invention, the dimming of the LEDs of module is equally easily possible as, for example, a periodic activation/deactivation.

1. A LED light module (M) for a lighting device for vehicles, the LED light module comprising:
at least one LED branch having at least one LED (LED1 . . . LEDn), wherein at least one bin classifying resistor (R_{R}, R′_{R}) is arranged on the module, and the module is designed for operation with a total current (I_{G}); and
an analog controller (3, T2) for branching off a partial current (I_{B}) which is connected in parallel with the LED branch (Z) carrying a partial current (I_{D}) of the total current (I_{G}),
wherein a signal (U_{S}) corresponding to the total current (I_{G}) is fed to the analog controller as a reference variable and a signal (U_{R}) proportional to one of the partial currents (I_{B}, I_{D}) and provided by the bin classifying resistor (R_{R}, R′_{R}) is fed to the analog controller as a control variable.

2. The LED light module (M) of claim 1, wherein the control variable is proportional to the partial current (I_{B}) branched off by the analog controller (3, T2).

3. The LED light module (M) of claim 2, wherein a resistor (R_{R}) is positioned in the branch of the analog controller (3, T2) for identifying a bin class, and the voltage drop (U_{R}) occurring on the same is supplied to the analog controller as a control variable.

4. The LED light module (M) of claim 1, wherein the control variable is proportional to the partial current (I_{D}) flowing through the LED branch (Z).

5. The LED light module (M) of claim 4, wherein the resistor (R′_{R}) is positioned in the LED branch (Z) for identifying a bin class, and the voltage drop (U′_{R}) occurring on the same is provided to the analog controller (3, T2) as a control variable.
